(19) United States
(12) Patent Application Publication
(10) Pub. No.: US 2005/0167184 A1
(43) Pub. Date: Aug. 4, 2005

(54) Torque detector with reflector for electric power steering system

(76) Inventors: Sun-Young Hong, Gyongnam (KR); Kwang-Suck Boo, Busan (KR)

Correspondence Address: LADAS & PARRY, 26 WEST 61ST STREET, NEW YORK, NY, 10023, US

(21) Appl. No.: 10/510,412

(22) PCT Filed: Apr. 25, 2003
(86) PCT No.: PCT/KR03/00850

(30) Foreign Application Priority Data
Apr. 26, 2002 (KR) 10-2002-0022965

(51) Int. Cl. B62D 5/04

(52) U.S. Cl. 180/446

(57) ABSTRACT

The present invention relates to a steering torque detecting apparatus of an electric power steering system which is capable of assisting a steering operation by accurately detecting a steering torque b providing a light incident groove having a reflections surface. In a steering system which includes an input shaft connected with a steering handle, an output shaft which is connected with vehicle wheels, an elastic member which connects the input shaft and output shaft to be rotatable in different directions at a certain angle, and a steering torque detector which is installed between the input shaft and the output shaft for thereby detecting a steering torque, there is provided a steering torque detector of a steering system which includes left and right reflections surfaces formed in one of the input shaft and output shaft, a light emitting element which is installed in a shaft corresponding to a shaft in which the reflection surface is formed, and left and right light receiving elements which are installed in left and right sides of the light emitting element and receive light of the light emitting element in accordance with a relative rotation of the input shaft and output haft.

### BACKGROUND OF THE INVENTION

1. Field of the Invention

The present invention relates to a torque detector with a reflector for an electric power steering system, and in particular to a torque detector with a reflector for an electric power steering system which is capable of decreasing the number of wires and elements, implementing a simple construction and enhancing a reliability and durability by providing a light incident groove having a reflection surface for thereby accurately detecting a steering torque.

2. Description of the Background Art

When rotating a steering handle when a vehicle runs or stops, a wheel contacting with a ground surface is moved in a certain direction corresponding thereto. Since a certain friction force is applied between a wheel and a ground surface, a large force is required for operating a steering handle. The steering torque detector of an electric power steering system is an apparatus for enhancing a steering convenience of a vehicle by measuring a rotations state of a steering handle and providing an assistant steering force to a steering shaft by an electric power motor.

In the electric power steering system, an input shaft connected with the steering handle and an output shaft connected with the wheels are connected by a torsion bar. The input shaft and output shaft are connected by the torsion bar in such a manner that the same are rotated in different directions, respectively, so that a steering torque inputted through the steering handle and input shaft are transferred to the output shaft by the torsion bar. When operating the steering handle, the torsion bar is deformed, so that a certain variation of a certain angle occurs between the input shaft and the output shaft. A steering torque detector is installed between the input shaft and the output shaft. The motor connected with the output shaft is controlled by a signal generated by the detector for thereby generating an assistant torque and supporting the steering operation.

The steering torque detector is classified into a contact type and a non-contact type based on the truth that whether the input shaft connected with the steering handle contacts with the steering shaft. In the contact type, there is a method in which a potentiometer or magnetic transformer. In the above contact type steering torque detector, the volume and weight are large, and a detection accuracy is bad, and a signal process is complicated. Since the steering shaft and the detector are contacted, an inherent torque characteristic of the steering shaft is affected.

In the non-contact type steering torque detector, there is not any contact with respect to the input shaft, and a mechanical construction is not complicated. The construction is simple for thereby decreasing a fabrication cost. It is possible to accurately detect the steering torque. Therefore, the non-contact type steering torque detector is largely used and substitutes the contact type steering torque detector.

In the Korean patent laid-open No. 99-276609-11, the steering torque detector of the electric power steering system has a light emitting element and a light receiving element in the input shaft and output shaft for thereby measuring a distorted angle between the output and input shafts.

However, the above conventional steering torque detector has a complicated construction, and it is difficult to process each element. It is not easy to install a light emitting element, light receiving element and wire in the input and output shafts. Therefore, the fabrication cost is increased, and the durability has erroneous problems.

In the steering torque detector of the Korean patent laid-open No. 97-040971, a slide is installed in a torsion bar to be moved upwardly and downwardly. A reflection plate is vertically extended in the slide. A light emitting element and light receiving element are installed in the upper and lower portions of the reflection plate. Therefore, the steering torque is detected using a reflection degree of light which is changed based on the upward and downward movements of the slide. In the above conventional steering torque detector, in order to upwardly and downwardly move the slide based on the rotation of the torsion bar, various elements should be provided in the torsion bar for thereby complicating the construction. In addition, in this case, the process and assembling are difficult.

In order to overcome the above problems, there is provided a steering torque detector. In the above conventional steering torque detector, a light emitting element is installed in one shaft between the input and output shafts, and a light receiving elements is installed in the other shaft. In an initial position in which the steering handle is not operated, the light emitting element and the light receiving element are not overlapped, and when the steering handle is operated, as the input shaft and output shaft are relatively rotated, so that the light emitting element and the light receiving element are partially overlapped. When the light receiving element is partially overlapped with the light emitting element, an electric signal is outputted in proportion to the degree of opening formed in such a manner that the two elements are overlapped, for thereby detecting the steering torque. In the thusly constructed conventional steering torque detector, the construction is simple. The wires should be separately connected in the light emitting element and light receiving element for thereby causing a difficult installation. Since there is a region in which the output signal of the light receiving element is sharply changed due to the degree of opening due to the optical characteristic of the light emitting element, it is not adaptable to use as a control signal.

FIG. 7 is a graph of an output electric signal of a light receiving element of the steering torque detector in the conventional art. The axis X represents an area in which the light receiving element and the reflection surface are overlapped, and the axis Y represents an output electric signal of the light receiving device.

As shown in FIG. 7, since the light emitting element has an intensity which is increased in the direction of its center portion, it is not in proportion to the degree of opening in which the light receiving element and the output electric signal are overlapped and is sharply changed at the moment that the light receiving element becomes close to the light emitting element. Therefore, the control signal inputted into the motor may be sharply changed, so that it is impossible to implement a smooth steering operation in the conventional art.

### SUMMARY OF THE INVENTION

Accordingly, it is an object of the present invention to provide a torque detector with a reflector for an electric power steering system which is capable of decreasing the numbers of wires and parts in an electric power steering system and implementing a simple construction.

It is another object of the present invention to provide a torque detector with a reflector for an electric power steering system which is capable of accurately detecting a steering torque by installing a steering torque detector having an improved reliability and durability.

In order to achieve the above objects, in a steering system which includes an input shaft connected with a steering handle, an output shaft which is connected with vehicle wheels, an elastic member which connects the input shaft and output shaft to be rotatable in different directions at a certain angle, and a steering torque detector which is installed between the input shaft and the output shaft for thereby detecting a steering torque, there is provided a torque detector with a reflector for an electric power steering system which includes left and right reflections surfaces formed in one of the input shaft and output shaft, a light emitting element which is installed in a shaft corresponding to a shaft in which the reflection surface is formed, and left and right light receiving elements which are installed in left and right sides of the light emitting element and receive light of the light emitting element in accordance with a relative rotation of the input shaft and output haft.

In the present invention, the left and right reflection surfaces are formed in the upper surfaces of left and right light incident grooves formed in an end portion of an input shaft flange integrally formed in the input shaft, and the light emitting element and left and right light receiving elements are installed an output shaft flange integrally formed in the output shaft in correspondence to the input shaft flange.

In addition, the left and right light incident grooves and left and right reflection surfaces are formed in such a manner that through hoes are formed in the input shaft flange, and a reflection plate is installed thereon.

A protrusion is formed in one of the output shaft flange and the input shaft flange, and a guide groove is formed in other shaft flange corresponding to the shaft in which the protrusion is formed, and the protrusion is inserted into the guide grove for thereby limiting a relative rotation angle of the input shaft.

The light emitting element induces a resistance which is in reverse proportion to the intensity of incident light.

### BRIEF DESCRIPTION OF THE DRAWINGS

The present invention will become better understood with reference to the accompanying drawings which are given only by way of illustration and thus are not limitative of the present invention, wherein;

FIG. 1 is a schematic view illustrating an electric power steering system with a steering torque detector according to an embodiment of the present invention;

FIG. 2 is a vertical cross sectional view illustrating a steering torque detector according to an embodiment of the present invention;

FIG. 3 is a partial perspective view illustrating a steering torque detector according to an embodiment of the present invention;

FIG. 4 is a partial cross sectional view illustrating a steering torque detector according to an embodiment of the present invention;

FIG. 5 is a partial plan view illustrating an operation state of a steering torque detector according to an embodiment of the present invention;

FIG. 6 is a graph of an output electric signal of a steering torque detector according to an embodiment of the present invention; and

FIG. 7 is a graph of an output electric signal of a photo detector of a steering torque detector in the conventional art.

### DETAILED DESCRIPTION OF THE PREFERRED EMBODIMENTS

The construction and operation of a steering torque detector of an electric power steering system according to the present invention will be described through the preferred embodiments of the present invention with reference to the accompanying drawings.

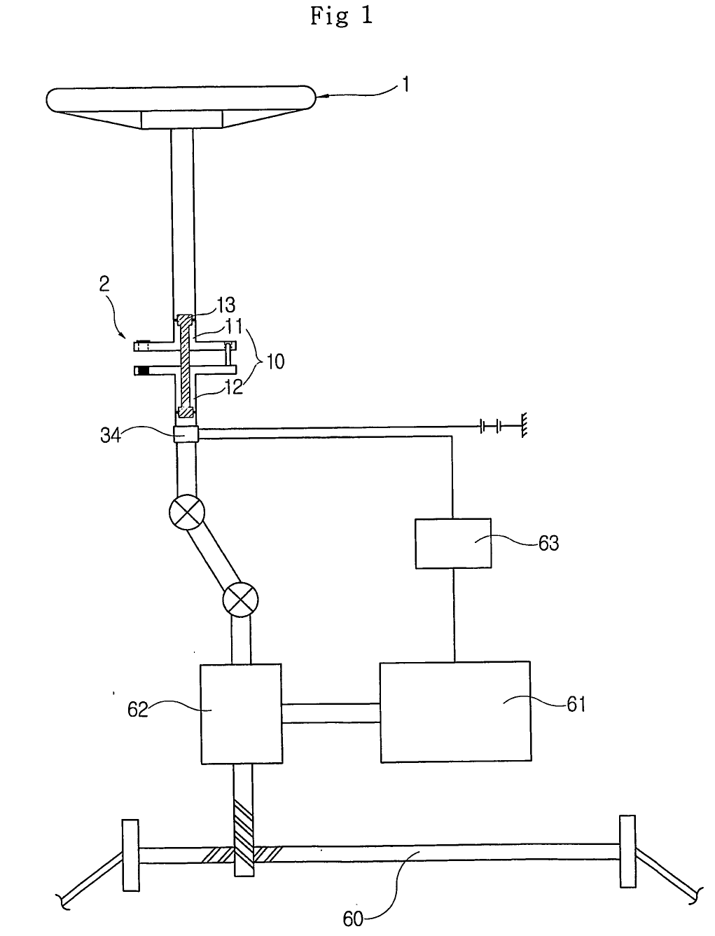

FIG. 1 is a schematic view illustrating an electric power steering system with a steering torque detector according to an embodiment of the present invention.

As shown therein, in the electric power steering system, the wheels (not shown) are steered based on a steering shaft 10 which is integrally rotated with a steering handle 1 and an operation of the steering handle 1 in which a steering link 60 in which the wheels are installed at both ends of the same, is connected with the steering shaft 10.

The steering shaft 10 is formed of an input shaft 11 and an output shaft 12. The input shaft 11 is rotated by the steering handle 1 for thereby transferring a rotational force, and the output shaft 12 is connected with the input shaft 11 by a torsion bar 13 which is formed of an electric member for thereby being rotated at a certain angle with respect to the input shaft 11.

A steering torque detector 2 is installed in the input shaft 11 and the output shaft 12, respectively, and a motor 61 is connected through a decelerator 62 on the output shaft 12 for thereby generating an assistant steering torque based on a detection signal from the steering torque detector 2. The motor 61 may be connected to the steering link 60 through the decelerator 62.

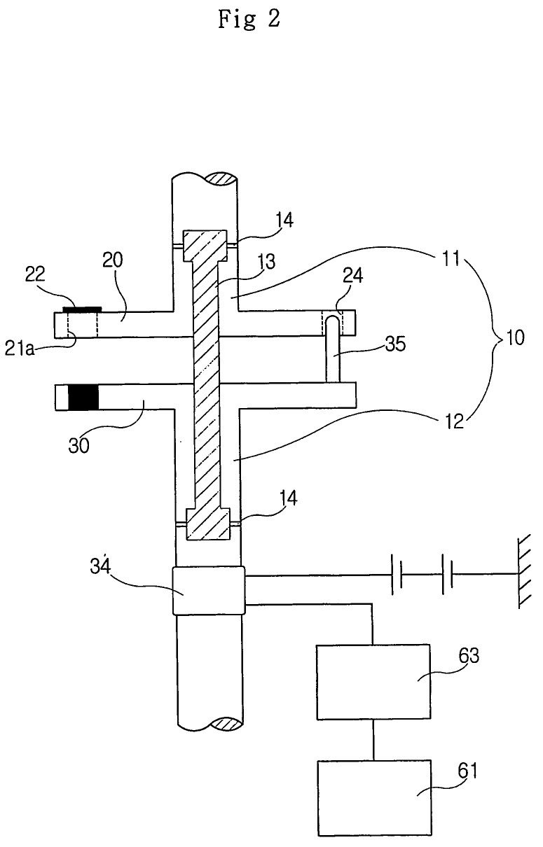

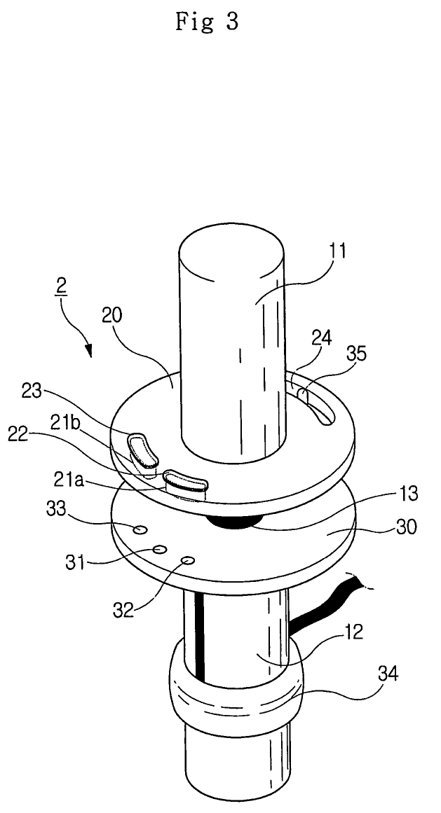

FIG. 2 is a vertical cross sectional view illustrating a steering torque detector according to an embodiment of the present invention, and FIG. 3 is a partial perspective view illustrating a steering torque detector according to an embodiment of the present invention.

As shown therein, the steering torque detector 2 according to the present invention includes left and right reflection plates 22 and 23 installed in the input shaft 11, respectively, a light emitting element 31 installed in the output shaft 12, and left and right light receiving elements 32 and 33.

The input shaft 11 and the output shaft 12 are connected by the torsion bar 13 which is an elastic member. One end of the torsion bar 13 is connected with the steering handle 1 and is inserted into a center portion of the input shaft 11 and is connected by a pin 14. The other end of the same is connected with the output shaft 12 by a pin 14. When a steering torque is transferred to the input shaft 11 based on an operation of the steering handle 1, a certain torsion force occurs in the torsion bar 13, so that the input shaft 11 and the output shaft 12 are relatively rotated.

An output shaft flange 30 is extended in an outer portion of the upper portion of the output shaft 12 corresponding to the input shaft 11, and a light emitting element 31 is inserted and installed in an end portion of one side of the output shaft flange 30, and the left and right light receiving elements 32 and 33 are installed in left and right portions of the light emitting element 31.

An input shaft flange 20 is extended in an outer portion of the lower portion of the input shaft 11 corresponding to the output haft 12. Two through holes are formed in the end portion of one side of the input shaft flange 20 for thereby forming left and right incident grooves 21a and 21b for thereby being corresponded to the left and right light receiving elements 32 and 33. The left and right reflection plates 22 and 23 are attached to the upper surfaces of the through holes for thereby operating as a reflection surface capable of reflecting light of the light emitting element 31.

When forming the reflection surface and the left and right incident grooves 21a and 21b in the input shaft flange 20, there may be various methods. In one method, a groove (not shown) is processed after an additional reflection plate is not attached, the inner upper surface is polished for thereby integrally forming the reflection surface (not shown).

The left and right light receiving elements 32 and 33 and the light emitting element 31 are connected with a wire portion 34 installed in the output shaft 12 for thereby externally receiving a power and externally outputting a signal. The left and right light receiving elements 32 and 33 are connected with an amplifier 63 of a power circuit which supplies power to the motor 61 through the wire portion 34 and induces a resistance which is in reverse proportion to the intensity of inputted light with respect to the power applied to the amplifier 63. Since only the left and right reflection plates 22 and 23 are installed in the input shaft 11, it is not needed to connect an additional wire.

A circumferential direction guide groove 24 having a certain length is formed in an outer portion of the rear end of the input shaft flange 20, and a protrusion 35 inserted into the guide groove 24 is formed in the output shaft flange 30. The input shaft 11 and the output shaft 12 are relatively rotated in a range in which the protrusion 35 is moved along the guide groove 24, and when the protrusion 35 is contacted with both ends of the guide groove 24, the input shaft 11 and the output shaft 12 do not rotated any more.

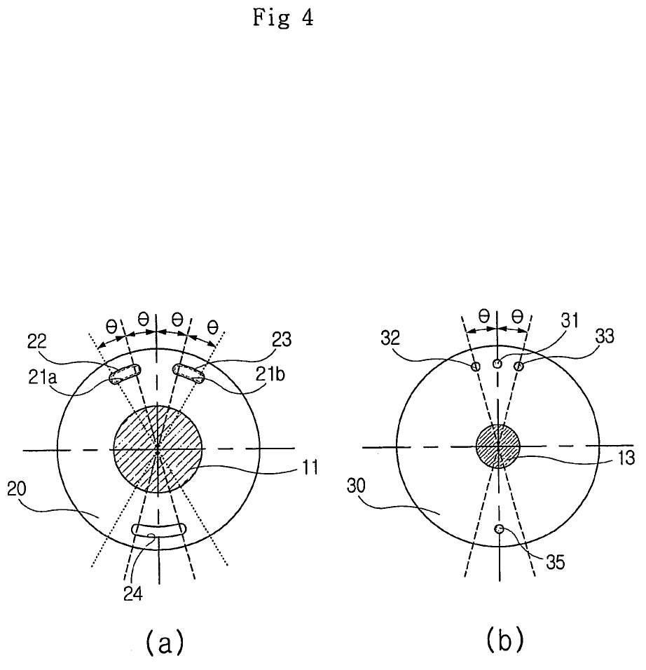

FIG. 4 is a partial cross sectional view illustrating a steering torque detector according to an embodiment of the present invention, of which FIG. 4A is a cross sectional view of an input shaft flange, and FIG. 4B is a cross sectional view of an output shaft flange.

As shown in FIG. 4B, the left and right light receiving elements 32 and 33 are installed to have a certain identical angle θ from the center of the light emitting element 31 with respect to a center of the output shaft 12, and the protrusion 35 is opposite to the light emitting element 31 in such a manner that the center of the same is positioned in a diagonal line passing through the center of the light emitting element 31.

As shown in FIG. 4A, left and right light incident grooves 21a and 21b are formed in the input shaft flange 20, and left and right reflection plates 22 and 23 are installed in the upper surface of the same. When a certain variation occurs in the input shaft 11 and the output shaft 12, the light of the light emitting element 31 passes through the light incident grooves 21a and 21b and is reflected by the reflection surfaces 22 and 23 and are made incident into the left and right light receiving elements 32 and 33. The left and right reflection plates 22 and 23 and the left and right light incident grooves 21a and 21b are formed in an elliptical shape. In this state, the left and right reflection plates 22 and 23 and the left and right light incident grooves 21a and 21b have a certain length in the circumferential direction so that the left reflection plate 22 and the left light incident groove 21a may be overlapped with the light emitting element 31 and the left light receiving element 32 at one time, and the right reflection plate 23 and the right light incident groove 21b are overlapped with the light emitting element 31 and the right light receiving element 33. The left and right reflection plates 22 and 23 are distanced in the left and right directions with respect to the light emitting element 31 so that one end of each left and right reflection plate 22 and 23 is overlapped with only the left and right light receiving elements 32 and 33 and is not overlapped with the light emitting element 31 in a state that the input shaft 11 and the output shaft 12 are not rotated relatively.

The protrusion 35 is inserted into the guide groove 24 and is moved in the left and right directions based on a relative rotation of the input shaft 11 and the output shaft 12, and the left and right movements are limited by the length of the guide groove 24. The length of the guide groove 24 is determined in such a manner that the input shaft 11 and the output shaft 12 are rotated at an angle range of θ.

When constructing a limit in the relative rotation angle of the input shaft 11 and the output shaft 12, various constructions may be adapted in addition to the construction that the protrusion 35 and the guide groove 24 are formed in the above manner.

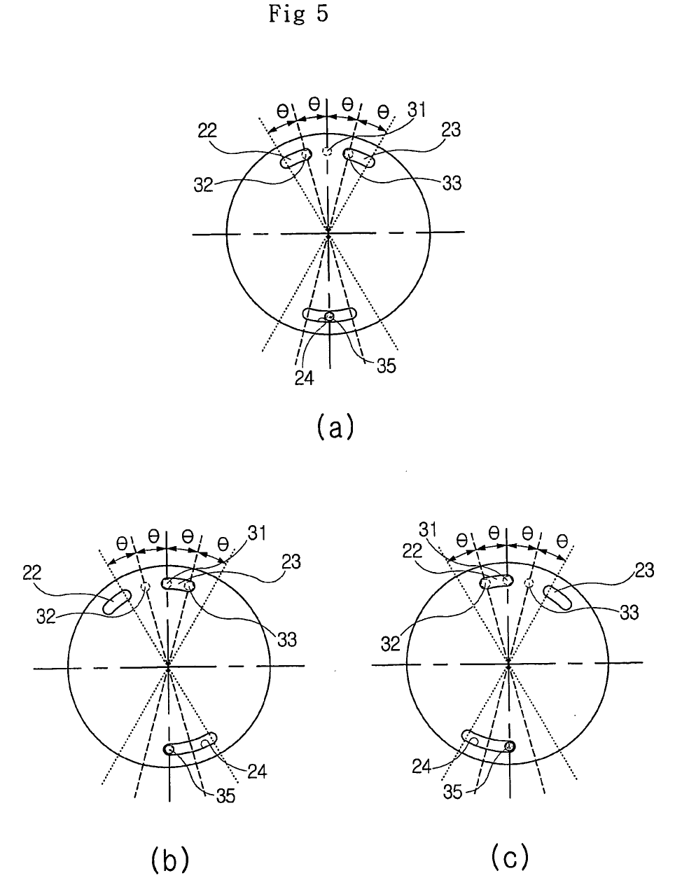

FIG. 5 is a partial plan view illustrating an operation state of a steering torque detector according to an embodiment of the present invention, of which FIG. 5A is a view illustrating a neutral state in which the input shaft 11 and the output shaft 12 are not relatively rotated, FIG. 5B is a view illustrating a left steering state in which the steering handle 1 is rotated in the left direction, and FIG. 5C is a right steering state in which the steering handle 1 is rotate din the right direction.

As shown in FIG. 5a, in a state that the steering handle 1 is not operated, the light of the light emitting element 31 is not inputted into the left and right light receiving elements 32 and 33, the left and right light emitting elements 32 and 33 have a unlimited resistance. Therefore, the power of the amplifier 63 is disconnected, and the motor 61 is not driven.

As shown in FIG. 5B, when the steering handle 1 is steered in the left direction, the input shaft 11 and the output shaft 12 are relatively rotated, and the right reflection surface 23 is partially overlapped with the light emitting element 31. The light from the light emitting element 31 is reflected by the reflection surface 23 and is made incident into the right light receiving element 33. The right light receiving element 33 has a resistance which is in reverse proportion to the area overlapped with the reflection surface 22 with respect to the power of the amplifier 63. Therefore, the power which is in proportion to the rotation angle of the input shaft 11 is inputted into the amplifier 63, so that the motor 61 outputs an assistant steering torque of a certain size corresponding to the rotational angle of the input shaft 11.

As shown in FIG. 5C, the steering handle 1 is steered in the right direction, and the left reflection surface 22 is partially overlapped with the light emitting element 31, and the light of the light emitting element 31 is inputted into the left light receiving element 32 for thereby obtaining a resistance which is in reverse proportion to the intensity of incident light.

Even when the steering handle 1 is rotated in the left direction or right direction by a few numbers, the movement of the protrusion 35 is limited by both ends of the guide groove 24, and the relative rotation of the input shaft 11 and the output shaft 12 is limited. Therefore, since the input shaft 11 is continuously relatively rotated with respect to the output shaft 12, it is possible to prevent the right reflection surface 23 from detecting the light and the right light receiving element 33 from detecting the light of the left reflection surface 22, for thereby preventing an error detection.

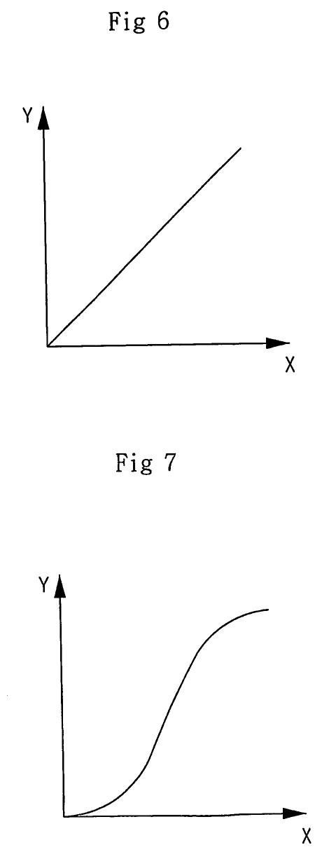

FIG. 6 is a graph of an output electric signal of a steering torque detector according to an embodiment of the present invention, in which the axis X represents an area in which the left and right light receiving elements 32 and 33 are overlapped with the left and right reflection plates 22 and 23, and the axis Y represents a current inputted into the amplifier 63 by a varying resistance of the light receiving element. As shown therein, since an electric signal inputted into the amplifier 63 by the steering torque detector 2 is in proportion to the area in which the left and right light receiving elements 32 and 33 are overlapped with the left and right reflection plates 22 and 23, the signal may be well adapted to be used as a control signal for controlling the motor 61. Therefore, it is possible to more accurately detect the steering torque.

As described above, in the steering torque detector of an electric power steering system according to the present invention, it is possible to assist a steering operation by accurately detecting the steering torque by providing a light incident groove having a reflection surface. It is not needed to connect a wire to the input shaft. The numbers of the wires and parts are decreased for thereby implementing a simple construction. An installation work is easy. The wires are not disconnected by the relative rotation of the input shaft and the output shaft for thereby enhancing a durability and reliability.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In a steering system which includes an input shaft connected with a steering handle, an output shaft which is connected with vehicle wheels, an elastic member which connects the input shaft and output shaft to be rotatable in different directions at a certain angle, and a steering torque detector which is installed between the input shaft and the output shaft for thereby detecting a steering torque, a steering torque detector of a steering system, comprising:
left and right reflections surfaces formed in one of the input shaft and output shaft;
a light emitting element which is installed in a shaft corresponding to a shaft in which the reflection surface is formed; and
left and right light receiving elements which are installed in left and right sides of the light emitting element and receive light of the light emitting element in accordance with a relative rotation of the input shaft and output haft.

2. The detector of claim 1, wherein said left and right reflection surfaces are formed in the upper surfaces of left and right light incident grooves formed in an end portion of an input shaft flange integrally formed in the input shaft, and the light emitting element and left and right light receiving elements are installed an output shaft flange integrally formed in the output shaft in correspondence to the input shaft flange.

3. The detector of claim 2, wherein said left and right light incident grooves and left and right reflection surfaces are formed in such a manner that through hoes are formed in the input shaft flange, and a reflection plate is installed thereon.

4. The detector of claim 2, wherein a protrusion is formed in one of the output shaft flange and the input shaft flange, and a guide groove is formed in other shaft flange corresponding to the shaft in which the protrusion is formed, and the protrusion is inserted into the guide grove for thereby limiting a relative rotation angle of the input shaft.

5. The detector of claim 1, wherein said light emitting element induces a resistance which is in reverse proportion to the intensity of incident light.
